(19) United States
(12) Patent Application Publication
(10) Pub. No.: US 2026/0340576 A1
(43) Pub. Date: Oct. 29, 2026

(54) PARCEL VOLUME PREDICTION METHOD AND APPARATUS, DEVICE, STORAGE MEDIUM, AND PROGRAM PRODUCT

(71) Applicant: BEIJING YOUZHUJU NETWORK TECHNOLOGY CO., LTD., Beijing (CN)

(72) Inventors: Congcong HU, Beijing (CN); Zhou YE, Beijing (CN)

(21) Appl. No.: 19/663,075

(22) Filed: Apr. 29, 2026

(30) Foreign Application Priority Data
Apr. 29, 2025 (CN) 202510559592.9

(51) Int. Cl. G06Q 10/087; G06Q 10/0631

(52) U.S. Cl. CPC G06Q 10/0872; G06Q 10/06315

(57) ABSTRACT

Provided are a parcel volume prediction method and apparatus, a device, a storage medium and a program product, the method includes: acquiring first time-series data of a first parcel within a first historical duration and parcel plan data for a first prediction time, the first time-series data indicating a relationship between a time node and parcel information; pre-processing the first time-series data to obtain second time-series data; and predicting, using a parcel volume prediction model, a parcel volume for the first prediction time to obtain a parcel volume prediction result for the area for the first prediction time.

### CROSS-REFERENCE TO RELATED APPLICATIONS

The present application is based on and claims priority to Chinese Patent Application No. 202510559592.9, and filed on Apr. 29, 2025, the entire disclosure of the Chinese Patent Application is hereby incorporated by reference in its entirety.

### TECHNICAL FIELD

The present disclosure relates to the field of logistics technologies, artificial intelligence technologies, large model technologies, and large language model technologies, and in particular, to a parcel volume prediction method and apparatus, a device, a storage medium, and a program product.

### BACKGROUND

In logistics business, accurate prediction of daily parcel volume is very important for warehouse staff scheduling. Especially in a business growth stage, the parcel volume may fluctuate greatly. For example, at some special time nodes, the parcel volume may change significantly. Therefore, the severe fluctuation of actual business data brings great difficulties to accurate parcel volume prediction.

### SUMMARY

In a first aspect, the present disclosure provides a parcel volume prediction method, the method includes:
acquiring first time-series data of a first parcel within a first historical duration and parcel plan data for a first prediction time, the first time-series data indicating a relationship between a time node and parcel information, the parcel information including an actual parcel volume and area information, and the area information indicating an area to which a resource acquisition space corresponding to a parcel belongs;
pre-processing the first time-series data to obtain second time-series data; and
predicting, using a parcel volume prediction model, a parcel volume for the first prediction time to obtain a parcel volume prediction result for the area for the first prediction time, the parcel volume prediction model being configured to output the parcel volume prediction result based on the second time-series data and the parcel plan data for the first prediction time.

In a second aspect, the present disclosure provides a parcel volume prediction apparatus. The apparatus includes:
an acquisition module configured to acquire first time-series data of a first parcel within a first historical duration and parcel plan data for a first prediction time, the first time-series data indicating a relationship between a time node and parcel information, the parcel information including an actual parcel volume and area information, and the area information indicating an area to which a resource acquisition space corresponding to a parcel belongs;
a preprocessing module configured to pre-process the first time-series data to obtain second time-series data; and
a prediction module configured to predict, using a parcel volume prediction model, a parcel volume for the first prediction time to obtain a parcel volume prediction result for the area for the first prediction time, the parcel volume prediction model being configured to output the parcel volume prediction result based on the second time-series data and the parcel plan data for the first prediction time.

In a third aspect, the present disclosure provides an electronic device. The electronic device includes: at least one memory and at least one processor. The at least one memory and the at least one processor are communicatively connected to each other. The at least one memory stores computer instructions. The at least one processor executes the computer instructions to perform the parcel volume prediction method according to the first aspect or any implementation corresponding to the first aspect.

In a fourth aspect, the present disclosure provides a computer-readable storage medium. The computer-readable storage medium stores computer instructions. The computer instructions cause a computer to perform the parcel volume prediction method according to the first aspect or any implementation corresponding to the first aspect.

In a fifth aspect, the present disclosure provides a computer program product. The computer program product includes computer instructions. The computer instructions cause a computer to perform the parcel volume prediction method according to the first aspect or any implementation corresponding to the first aspect.

### BRIEF DESCRIPTION OF THE DRAWINGS

In order to more clearly explain the technical solutions in the specific embodiments of the present disclosure or in the related art, the following will briefly introduce the drawings that need to be used in the description of the specific embodiments or the related art. Obviously, the drawings in the following description are some embodiments of the present disclosure. For those of ordinary skill in the art, other drawings may be obtained based on these drawings without paying creative efforts.

FIG. 1 is a schematic diagram of an application scenario according to an embodiment of the present disclosure;

FIG. 2 is a schematic flowchart of a parcel volume prediction method according to an embodiment of the present disclosure;

FIG. 3 is a schematic flowchart of another parcel volume prediction method according to an embodiment of the present disclosure;

FIG. 4 is a schematic flowchart of yet another parcel volume prediction method according to an embodiment of the present disclosure;

FIG. 5 is a schematic diagram of training of a parcel volume prediction model and parcel volume prediction according to an embodiment of the present disclosure;

FIG. 6 is a structural block diagram of a parcel volume prediction apparatus according to an embodiment of the present disclosure; and

FIG. 7 is a schematic hardware structural diagram of an electronic device according to an embodiment of the present disclosure.

### DETAILED DESCRIPTION OF EMBODIMENTS

In order to make the purposes, technical solutions and advantages of embodiments of the present disclosure clearer, the technical solutions in the embodiments of the present disclosure will be clearly and completely described below in combination with the drawings in the embodiments of the present disclosure. Obviously, the described embodiments are part of the embodiments of the present disclosure, but not all of the embodiments. Based on the embodiments in the present disclosure, all other embodiments obtained by those skilled in the art without paying creative work belong to the protection scope of the present disclosure.

It may be understood that before using the technical solutions disclosed in the embodiments of the present disclosure, a user should be informed of the type, range of usage, usage scenario, etc. of personal information involved in the present disclosure in an appropriate manner in accordance with relevant laws and regulations, and the authorization of the user should be obtained.

For example, in response to receiving an active request from a user, prompt information is sent to the user to clearly inform the user that the operation requested to be performed will require access to and usage of the user's personal information. In this way, the user may independently choose whether to provide the personal information to software or hardware such as an electronic device, an application, a server, or a storage medium that performs the operation of the technical solution of the present disclosure according to the prompt information.

As an alternative but non-limiting implementation, in response to receiving an active request from the user, the prompt information may be sent to the user in the form of a pop-up window, for example, and the prompt information may be presented in text in the pop-up window. In addition, the pop-up window may further include a selection control for the user to choose whether to "agree" or "disagree" to provide the personal information to the electronic device.

It may be understood that the above process of notifying and acquiring the authorization from the user is merely illustrative and is not intended to limit the implementations of the present disclosure. Other manners that satisfy the requirements of relevant laws and regulations may also be applied to the implementations of the present disclosure.

In addition, it may be understood that the data involved in the technical solution (including but not limited to the data itself, the acquisition of the data, or the usage of the data) should comply with the requirements of corresponding laws, regulations, and related provisions.

In the related art, time-series forecasting techniques, including but not limited to Moving Average (MA), Autoregressive Integrated Moving Average with Exogenous Variables (ARIMAX), Prophet (a time-series forecasting model designed specifically to handle time-series data with strong seasonality, trend changes, and missing and outliers), Autoformer (a deep learning model to handle time-series forecasting tasks), Informer (a Transformer for Long Sequences Time-Series Forecasting), and PatchTST (a Transformer-based Time-series Forecasting method), are usually used for logistics parcel volume forecasting.

The Moving Average (MA) method is simple, but its shortcoming is to perform predictions for a single variable and cannot accurately predict parcel volume peaks in special periods such as sale promotions.

The Autoregressive Integrated Moving Average with Exogenous Variables (ARIMAX) model has the ability of multi-variable prediction, but it has strict requirements on data and requires the data to be stationary, while business data in a growth period with frequent sale promotion activities usually does not meet the stationarity condition, which limits the application of ARIMAX.

The Prophet model may capture information such as trends and seasons of time-series data and use future known covariates to assist in forecasting, but it is more suitable for long-term forecasting, is insensitive to short-term data trend changes, and has a poor forecasting effect when the logistics parcel volume fluctuates rapidly in a short period of time.

The Autoformer model may adaptively learn the trend and periodicity of time-series data, but it cannot use future known covariates and perform multi-variable prediction, which is difficult to meet forecasting requirements of the current logistics business.

The Informer model may greatly reduce the computing resources and training time through a sparse self-attention mechanism and has the ability to handle multiple variables, but it cannot use future known variables, and cannot distinguish between primary and covariate variables, which makes it difficult to distinguish the impact degree of each variable on parcel volume prediction in practical applications.

The PatchTST model divides time-series into patches, which can reduce the computational complexity while retaining the local information in the sequence and can better learn the characteristic patterns in the time-series, but it cannot use future known variables nor learn the correlation between multiple variables, which makes it difficult to handle the mutual influence between multiple factors in logistics parcel volume prediction.

Based on this, according to the parcel volume prediction method provided in an embodiment of the present disclosure, the parcel volume is predicted based on the parcel plan data, the prediction time, and the first time-series data within the first historical duration, which not only considers the historical actual parcel volume, but also considers the plan data at the prediction time, and may quickly adjust the prediction result according to recent data changes, thereby improving the accuracy of parcel volume prediction and meeting the requirements of efficient capacity arrangement for logistics business.

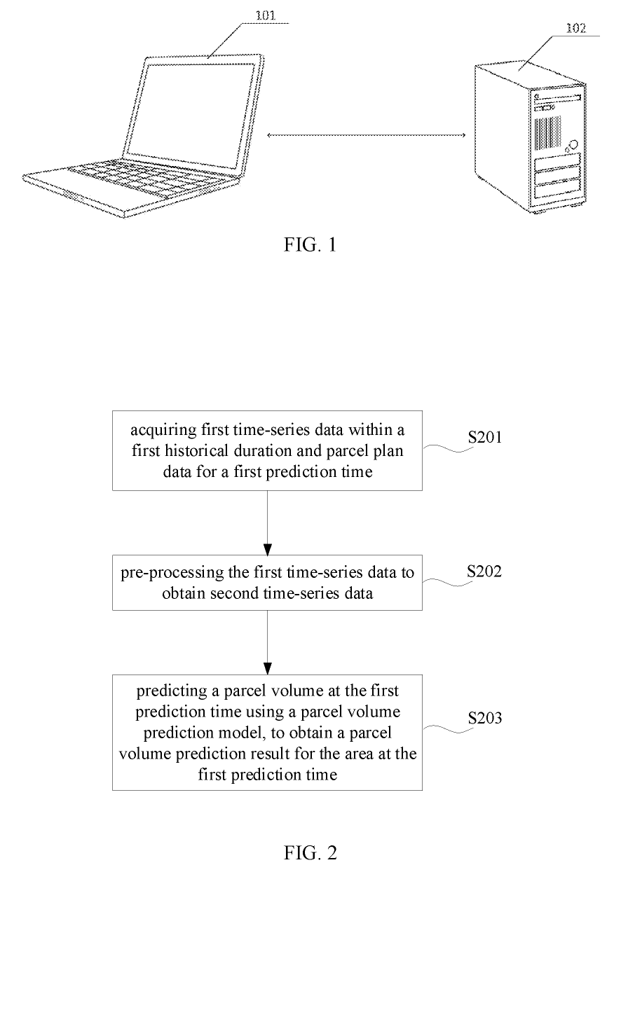

As an optional application scenario of an embodiment of the present disclosure, as shown in FIG. 1, the application scenario includes a terminal 101 and a server 102. The server 102 performs the parcel volume prediction method provided in an embodiment of the present disclosure to obtain the parcel volume prediction result for the first prediction time, and feeds back the obtained parcel volume prediction result to the terminal 101. A logistics dispatcher may know the parcel volume prediction result for the first prediction time through the terminal 101 and perform logistics dispatching based on the parcel volume prediction result.

Certainly, the parcel volume prediction result may also be used for other downstream applications, which are not limited herein and can be determined based on a specific application scenario.

According to an embodiment of the present disclosure, an embodiment of a parcel volume prediction method is provided. It should be noted that the steps shown in the flowcharts of the drawings may be performed in a computer system, for example, through a set of computer executable instructions, and although the logical sequence is shown in the flowcharts, in some cases, the steps shown or described may be performed in an order different from that herein.

In this embodiment, a parcel volume prediction method is provided, which may be used in a logistics scenario, FIG. 2 is a flowchart of the parcel volume prediction method according to an embodiment of the present disclosure. As shown in FIG. 2, the process includes the following steps.

Step S201: acquiring first time-series data within a first historical duration and parcel plan data for a first prediction time.

The first time-series data indicates a relationship between a time node and parcel information, the parcel information includes an actual parcel volume and area information, the area information indicates an area to which a resource acquisition space corresponding to a parcel belongs.

The first historical duration indicates a duration extending from the current time backward. The duration may be 14 days, 10 days, 7 days, etc., which may be specifically set according to actual requirements and will not be limited herein. For example, the current time is Apr. 15th, and the first historical duration indicates the period of time from Apr. 1st to Apr. 14th.

The first time-series data indicates the relationship between the time node and the parcel information. The time node may be each day, the parcel information includes the actual parcel volume and the area information, the actual parcel volume may represent the parcel volume actually generated every day, and the area information indicates the area to which the resource acquisition space corresponding to the parcel belongs. Specifically, the resource acquisition space is configured to provide item resources, an item resource needs to be transported from position A to position B in a form of parcel, since the same resource acquisition space has a relatively large number of item resources and not all item resources are necessarily transported from position A, therefore, to simplify the complexity of data statistics, parcel volume statistics can be performed in dimensions of the resource acquisition space.

The same area may include a plurality of resource acquisition spaces, and the same resource acquisition space may provide a plurality of item resources. The parcel information in the first time-series may represent the area to which the resource acquisition space corresponding to the parcel belongs. For example, item resource 1 to item resource 10 all come from a resource acquisition space a1, and the resource acquisition space a1 belongs to an area c1, then the area information of the parcel corresponding to item resource 1 to item resource 10 is area c1 to which the resource acquisition space a1 belongs.

The first time-series data within the first historical duration indicates the relationship between the time node and the parcel information, and thus, taking a time node 1 as an example, the time-series data may be represented in the following form:
time node 1-parcel p1-resource acquisition space a1-area c1;
time node 1-parcel p2-resource acquisition space a1-area c1;
time node 1-parcel p3-resource acquisition space a2-area c1; and
time node 1-parcel p4-resource acquisition space a3-area c2.

It may be learned from the above example that the time node 1 corresponds to parcels p1 to p3, which come from the resource acquisition space a1 to the resource acquisition space a3, respectively, and accordingly, areas c1 and c2.

Certainly, the data dimensions included in the first time-series data are not limited to those shown above, and other data dimensions may also be included, which is not limited herein.

The first prediction time indicates a time node for prediction. For example, the current time is Apr. 15th, and the first prediction time includes Apr. 16th to Apr. 26th. Certainly, the prediction duration corresponding to the first prediction time is not limited herein, and may be 14 days, 10 days, etc.

The parcel plan data for the first prediction time can be organized by the time node dimension, and may be given for each time node. The parcel plan data for the first prediction time may be obtained from a resource recommendation platform, before resource recommendation is performed on the resource recommendation platform for the resource acquisition space, the parcel plan data may be configured on the resource recommendation platform, and accordingly, the parcel plan data may be acquired. Certainly, the parcel plan data may also be acquired in other manners, which is not limited herein.

Step S202: pre-processing the first time-series data to obtain second time-series data.

The pre-processing includes at least one of time-series data division, time-series data arrangement, and time-series data discretization.

Since the first time-series data includes a relatively large number of data dimensions, if the time-series data is divided only in the area dimension, the amount of time-series data may be relatively small. Therefore, the dimension may be further refined on the basis of the area dimension, that is, the time-series data may be divided in finer granularity. For example, the dimension of the resource acquisition space or the dimension of the resource provider to which the resource acquisition space belongs may be used. The same resource provider may have a plurality of resource acquisition spaces, and the plurality of resource acquisition spaces may be in the same area or in different areas.

The time-series data arrangement includes data filling, data validity screening, etc., for time-series data. For example, if there is no parcel volume at a time node in the resource acquisition space, the parcel volume at the time node may be filled with 0, to ensure the continuity of time and the consistency of data length.

The time-series data discretization is used to perform discretization on the time-series data, ensuring that the processed time-series data may be used to perform a time-series regression task using the large language model.

Certainly, the pre-processing of the first time-series data is not limited to that shown above, and other processing manners may be included, which is not limited herein.

Step S203: predicting, using a parcel volume prediction model, a parcel volume for the first prediction time to obtain a parcel volume prediction result of an area for the first prediction time.

The parcel volume prediction model is configured to output the parcel volume prediction result based on the second time-series data and the parcel plan data for the first prediction time.

The input of the parcel volume prediction model is configured to include the second time-series data and the parcel plan data for the first prediction time, and the output of the parcel volume prediction model is configured to be the parcel volume prediction result. The parcel volume prediction model is built based on a large language model, and specifically, the base model of the parcel volume prediction model is not limited. For example, a non-artificially aligned base model may be selected.

According to the parcel volume prediction method provided in this embodiment, the first time-series data within the first historical duration and the parcel plan data for the first prediction time are acquired, the first time-series data is pre-processed to obtain the second time-series data, and the parcel volume prediction model is used to predict the parcel volume for the first prediction time to obtain the parcel volume prediction result for the area for the first prediction time. The first time-series data indicates the relationship between the time node and the parcel information, and the parcel information includes the actual parcel volume and the area information, that is, the actual parcel volume and the area information of the parcel at each time node within the first historical duration are acquired. The pre-processing includes at least one of time-series data division, time-series data arrangement, and time-series data discretization, which ensures the diversity, discretization, etc., of the second time-series data, and provides favorable input data for subsequent processing of the parcel volume prediction model. When the parcel volume prediction model is used for parcel volume prediction, not only the historical actual parcel volume is considered, but also the plan data for the prediction time is considered, while the prediction result may be quickly adjusted according to recent data changes, thereby improving the accuracy of parcel volume prediction and meeting the requirements of efficient capacity arrangement for logistics business.

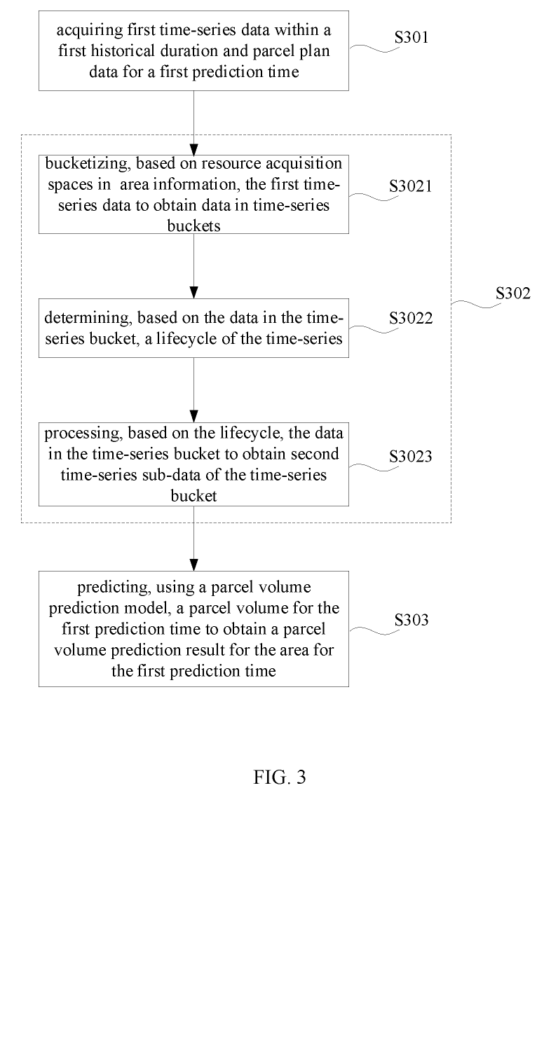

In the embodiment, a parcel volume prediction method is provided, which may be used in a logistics scenario, FIG. 3 is a flowchart of the parcel volume prediction method according to an embodiment of the present disclosure. As shown in FIG. 3, the process includes the following steps.

Step S301: acquiring first time-series data within a first historical duration and parcel plan data for a first prediction time.

The first time-series data indicates a relationship between a time node and parcel information, the parcel information includes an actual parcel volume and area information, the area information indicates an area to which a resource acquisition space corresponding to a parcel belongs. For details, reference may be made to step S201 of the embodiment shown in FIG. 2, which is not limited herein.

Step S302: pre-processing the first time-series data to obtain second time-series data.

The pre-processing includes at least one of time-series data division, time-series data arrangement, and time-series data discretization.

Exemplarily, step S302 includes the following steps.

Step S3021: bucketizing, based on the resource acquisition spaces in the area information, the first time-series data to obtain data in time-series buckets.

The data in a time-series bucket includes time-series sub-data of a plurality of resource acquisition spaces in the same area.

As described above, the resource acquisition space may belong to a certain area, and thus, the first time-series data is refined in the dimension of the resource acquisition space, that is, the time-series sub-data of the plurality of resource acquisition spaces in the same area are divided into the same time-series bucket.

The number of resource acquisition spaces included in the same time-series bucket can be set according to actual requirements. For example, if there are a relatively large number of resource acquisition spaces in the same area, the resource acquisition spaces in the same area may be divided into different time-series buckets, that is, the same area corresponds to a plurality of time-series buckets, if there are a relatively small number of resource acquisition spaces in the same area, the resource acquisition spaces in the same area may be divided into the same time-series bucket.

The bucketizing of the first time-series data may also be related to other factors, which will not be listed here.

The first time-series data is a general term for all time-series data within the first historical duration, the time-series data corresponding to the resource acquisition spaces in the same area comes from the first time-series data, and for the convenience of description, may be referred to as time-series sub-data. It should be noted that the time-series sub-data is a part of the first time-series data, and it may also be understood that the time-series sub-data is a data segment in the first time-series data.

In some optional implementations, step S3021 includes the following steps.
Step a1: determining resource acquisition spaces in the same area in the first time-series data and a number of time-series buckets; and
Step a2: bucketizing, based on the resource acquisition spaces in the same area and the number of time-series buckets, the first time-series data to obtain the data in the time-series buckets.

The number of time-series buckets may be set in advance, or may be obtained through adaptive adjustment of the data volume of the first time-series data, and the specific number of time-series buckets is not limited herein.

For the resource acquisition spaces in the same area in the first time-series data, the time-series data in the first time-series data may be first divided into areas, and then the time-series data in the same area may be divided into resource acquisition spaces, and finally, the time-series data of the resource acquisition spaces in the same area may be obtained.

In conjunction with the number of time-series buckets and the resource acquisition spaces in the same area, the first time-series data is bucketized, that is, the time-series data of at least one resource acquisition space in the same area is divided into the same time-series bucket to obtain the data in the time-series bucket.

The first time-series data is bucketized according to the number of time-series buckets and the resource acquisition spaces in the same area, ensuring that the data in the same time-series bucket is the time-series sub-data of the plurality of resource acquisition spaces in the same area, and the granularity is relatively fine, which may ensure the diversity of time-series data.

Step S3022: determining, based on the data in the time-series bucket, a lifecycle of the time-series bucket.

In the same time-series bucket, the same resource acquisition space may generate a plurality of pieces of time-series data within the first historical duration, and some resource acquisition spaces may be shut down at a certain time node within the first historical duration, while some resource acquisition spaces may start at a certain time node within the first historical duration. Therefore, for the time-series data in the same time-series bucket, although the defined duration is the first historical duration, the different shutdown times or start times of the resource acquisition spaces may cause the complexity of the time-series data in the time-series bucket in the dimension of the time node. In view of this, it is necessary to determine the lifecycle of the time-series bucket for the time-series bucket, and on this basis, the time-series data in the time-series bucket may be sorted out.

A lifecycle of a time-series bucket indicates a duration from the start time of the lifecycle to the end time of the lifecycle. The lifecycle of the time-series bucket can be determined based on the data in the time-series bucket, and exemplarily, it can be determined based on the earliest time when the parcel volume is generated and the latest time when the parcel volume is generated in the time-series bucket.

In some optional implementations, step S3022 includes the following steps.
Step b1: acquiring, for the data in the time-series bucket, a first time when a parcel volume first exists and a second time when a parcel volume last exists; and
Step b2: using the first time as a start time of the lifecycle and the second time as an end time of the lifecycle.

For the data in the time-series bucket, the time when a parcel volume first exists corresponding to each resource acquisition space may be queried, and the time when a parcel volume last exists may be obtained. Further, according to the resource acquisition spaces in the time-series bucket, the times when a parcel volume first exists corresponding to respective resource acquisition spaces may be compared, and the earliest time is used as the time when a parcel volume first exists in the time-series bucket and is recorded as the first time. The times when a parcel volume last exists corresponding to respective resource acquisition spaces are compared, and the latest time is used as the time when a parcel volume last exists in the time-series bucket and is recorded as the second time.

Since the first time and the second time correspond to the time-series bucket, the first time is used as the start time of the lifecycle, and the second time is used as the end time of the lifecycle.

The lifecycle is determined based on the first time when a parcel volume first exists and the second time when a parcel volume last exists, ensuring that the lifecycle is determined based on the actual times when the parcels occur, and the accuracy of the lifecycle of the time-series bucket can be ensured.

Step S3023: processing, based on the lifecycle, the data in the time-series bucket to obtain second time-series sub-data of the time-series bucket.

The second time-series data includes the second time-series sub-data of all time-series buckets.

After the lifecycle of the time-series bucket is determined, the time-series data of the time-series bucket represents the parcel information within the continuous duration of the lifecycle. Since some resource acquisition spaces may not generate parcel volumes at a certain time point, it is necessary to fill the parcel volume at that time point with zero.

In addition, the time-series data in the time-series bucket corresponds to a plurality of resource acquisition spaces, and to perform subsequent prediction in the dimension of time-series bucket, the time-series data of the plurality of resource acquisition spaces may be fused in the dimension of time node to obtain the second time-series sub-data of the time-series bucket. The second time-series sub-data of all time-series buckets is collectively referred to as the second time-series data.

In some optional implementations, step S3023 includes the following steps.
Step c1: performing parcel volume filling for a full lifecycle for time-series sub-data of the resource acquisition space in the time-series bucket to obtain third time-series sub-data of the resource acquisition space.
Step c2: merging parcel volumes at a same time node for the third time-series sub-data of all resource acquisition spaces in the time-series bucket to obtain the second time-series sub-data of the time-series bucket.

For the time-series sub-data of each resource acquisition space in the same time-series bucket, the parcel volume filling for continuous time nodes in the full lifecycle is performed. For example, the lifecycle of the time-series bucket is from Apr. 1st to Apr. 14th, and if no parcel volume is generated at the time node of Apr. 8^{th} for a certain resource acquisition space, the parcel volume of the resource acquisition space at the time node of Apr. 8th is filled with zero.

To distinguish from the time-series sub-data before filling, the filled time-series sub-data is referred to as third time-series sub-data. For all resource acquisition spaces in the time-series bucket, the parcel volumes at the same time node are merged to obtain the total parcel volume of the time-series bucket at the time node, and accordingly, the second time-series sub-data of the time-series bucket can be obtained.

The parcel volume filling for the full lifecycle is performed for the time-series sub-data of the resource acquisition space in the time-series bucket, which facilitates the subsequent merging according to the time node; in addition, the parcel volumes at the same time node are merged for the third time-series sub-data of all resource acquisition spaces in the time-series bucket, which may balance the diversity of time-series data and the stability of a target variable.

In some optional implementations, step c2 includes the following steps.
Step c21: accumulating the parcel volumes at the same time node for all third time-series sub-data in the time-series bucket to obtain fourth time-series sub-data.
Step c22: performing feature discretization on the fourth time-series sub-data to obtain the second time-series sub-data.

Corresponding to the same time-series bucket, for the third time-series sub-data of all resource acquisition spaces, the parcel volumes at the same time node are accumulated to obtain the total parcel volume at that time point, and so on, the fourth time-series sub-data of the time-series bucket can be obtained.

Since the parcel volume corresponding to different time nodes may vary greatly, for example, if some specified time nodes are included, the parcel volume may be greatly increased. Therefore, after the fourth time-series sub-data is obtained, discretization is performed on the fourth time-series sub-data to prevent overfitting in the subsequent model processing. The time-series sub-data obtained after the feature discretization of the fourth time-series sub-data is the second time-series sub-data.

Exemplarily, the feature discretization includes, but is not limited to, equal-frequency discretization, equidistant discretization, or stepped discretization, etc. The specific feature discretization manner used is determined according to actual requirements and is not limited herein.

After the fourth time-series sub-data is obtained by accumulating the parcel volumes at the same time node, on this basis, the feature discretization is performed on the fourth time-series sub-data, which facilitates the subsequent processing of the time-series regression task using the parcel volume prediction model.

In some optional implementations, step c22 includes the following steps.
Step c221: determining an initial discretization coefficient and a minimum value of parcel volumes in the fourth time-series sub-data, and using the minimum value as a reference value;
Step c222: determining a modified discretization coefficient based on a size relationship between a planned parcel volume corresponding to a time node in the fourth time-series sub-data and the reference value;
Step c223: modifying, based on the initial discretization coefficient and the modified discretization coefficient, the reference value to obtain an equidistant parameter for the time node; and
Step c224: processing, based on the equidistant parameter, a parcel volume corresponding to the time node to obtain the second time-series sub-data
In this embodiment, the feature discretization can be performed in the manner of stepped discretization. The stepped discretization is related to the equidistant parameter, and the equidistant parameters corresponding to different time nodes may be different.

After the above filling and accumulation for the full lifecycle, the parcel volumes corresponding to the continuous time nodes can be obtained. For example, there are 15 parcels on Apr. 13th, 20 parcels on Apr. 14th, 13 parcels on Apr. 15th, etc. A certain time node in the continuous time nodes may be a specified time node, at this time the parcel volume may surge, for example, increase to 100,000 parcels. Therefore, when the feature discretization is performed, to ensure that the data space corresponding to the processed data is relatively small, different equidistant parameters are required to process different parcel volumes. That is, the greater the parcel volume, the greater the equidistant parameter.

Specifically, the initial discretization coefficient is set, the parcel volumes corresponding to respective time nodes in the fourth time-series sub-data are compared, the minimum value of parcel volume is determined, and the minimum value of parcel volume is used as the reference value. The planned parcel volumes corresponding to the time nodes in the fourth time-series sub-data are acquired, since the resource acquisition space in the time-series bucket may be known, and each time node has its own planned parcel volume in the resource acquisition space, the planned parcel volumes corresponding to the time nodes in the fourth time-series sub-data may be obtained.

In the fourth time-series sub-data, the planned parcel volume corresponding to each time node is compared with the reference value in terms of size, for example, a multiple relationship between the planned data and the reference value can be determined, and the modified discretization coefficient can be determined accordingly. For example, if the ratio of the planned data to the reference value is between 2 and 3, the modified discretization coefficient is determined to be 2; if the ratio of the planned data to the reference value is between 3 and 4, the modified discretization coefficient is determined to be3.

The reference value is modified using the initial discretization coefficient and the modified discretization coefficient, for example, a product of the initial discretization coefficient, the modified discretization coefficient, and the reference value is calculated, and the product is used as the equidistant parameter for the time node. After the equidistant parameter is obtained, the parcel volume is processed using the equidistant parameter for the time node to obtain the parcel volume of the time node after the discretization, and so on, the second time-series sub-data of the time-series bucket may be obtained.

Different modified discretization coefficients are used for different parcel volumes, that is, overfitting of the model may be prevented by means of stepped discretization.

Step S303: predicting, using a parcel volume prediction model, a parcel volume for the first prediction time to obtain a parcel volume prediction result for the area for the first prediction time.

The parcel volume prediction model is configured to output the parcel volume prediction result based on the second time-series data and the parcel plan data for the first prediction time. For details, reference may be made to step S203 of the embodiment shown in FIG. 2, which is not limited herein.

According to the parcel volume prediction method provided in this embodiment, the area dimension is further refined to the dimension of resource acquisition space, which may improve the diversity of data. Meanwhile, the data in the time-series bucket is processed based on the lifecycle of the time-series bucket, which may eliminate abnormal data, reduce the data processing amount, and ensure the reliability of the second time-series data.

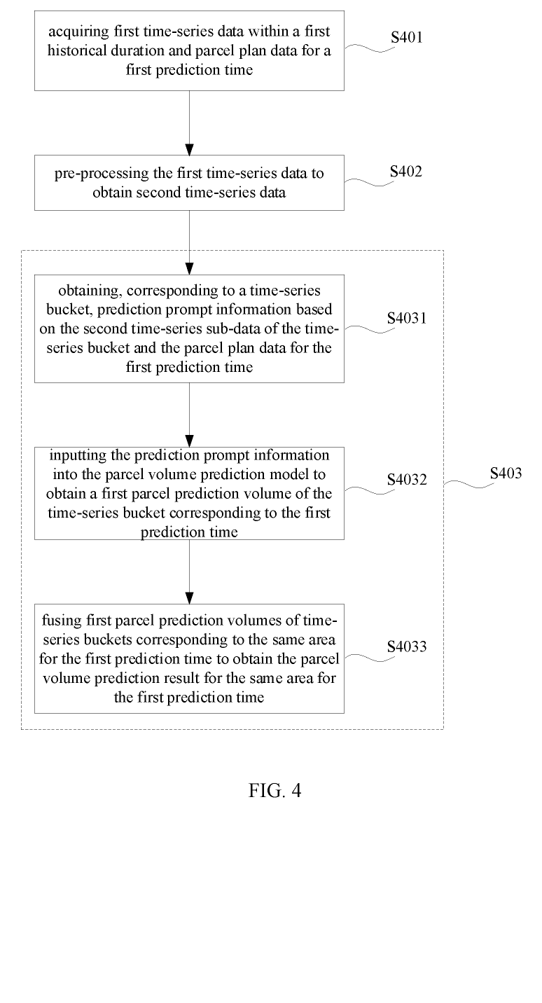

In the embodiment, a parcel volume prediction method is provided, which may be used in a logistics scenario, FIG. 4 is a flowchart of the parcel volume prediction method according to an embodiment of the present disclosure, as shown in FIG. 4, the process includes the following steps.

Step S401: acquiring first time-series data within a first historical duration and parcel plan data for a first prediction time.

The first time-series data indicates a relationship between a time node and parcel information, the parcel information includes an actual parcel volume and area information, the area information indicates an area to which a resource acquisition space corresponding to a parcel belongs. For details, reference may be made to step S201 of the embodiment shown in FIG. 2, which is not repeated herein.

Step S402: pre-processing the first time-series data to obtain second time-series data.

The pre-processing includes at least one of time-series data division, time-series data arrangement, and time-series data discretization. For details, reference may be made to step S202 of the embodiment shown in FIG. 2, or step S302 of the embodiment shown in FIG. 3, which is not repeated herein.

Step S403: predicting, using a parcel volume prediction model, a parcel volume for the first prediction time to obtain a parcel volume prediction result for the area for the first prediction time.

The parcel volume prediction model is configured to output the parcel volume prediction result based on the second time-series data and the parcel plan data for the first prediction time.

Exemplarily, step S403 includes the following steps.

Step S4031: obtaining, corresponding to the time-series bucket, prediction prompt information based on the second time-series sub-data of the time-series bucket and the parcel plan data for the first prediction time.

The second time-series sub-data represents historical time-series data, and the parcel plan data for the first prediction time represents future plan data and future time, the prediction prompt information can be obtained based on the historical time-series data, the future plan data, and the future time. Exemplarily, the prediction prompt information may be generated based on a prompt template, the prompt template includes fixed fields and corresponding variables, the second time-series sub-data and the parcel plan data for the first prediction time are used as variables to be filled in the variables of the corresponding fixed fields to obtain the prediction prompt information.

In some optional implementations, the prediction prompt information includes input prompt information and output prompt information. The input prompt information includes an input identification, the parcel plan data for the first prediction time, the first prediction time, and parcel target data, parcel actual data, and historical time that are obtained based on the second time-series sub-data of the time-series bucket. The output prompt information includes a field of predicted parcel volume and a prediction duration.

Specifically, if the parcel volume in N days needs to be predicted, in the input prompt information, there are N pairs of the parcel plan data for the first prediction time and the first prediction time, and each data pair is in a one-to-one correspondence with the first prediction time. If the acquired first historical duration is M days, there are M groups of parcel target data, parcel actual data, and historical time, and each group of data is in a one-to-one correspondence with the historical time.

The output prompt information includes the field of predicted parcel volume and the prediction duration. The prediction duration corresponds to the first prediction time in the input prompt information, for example, N days.

The prediction prompt information includes the input prompt information and the output prompt information, that is, an input-output data pair, since the time-series data for logistics parcel volume prediction has both future known covariates and historical multiple-variable information, the historical parcel volume and the plan data are included in the prediction prompt information in the form of input-output data pair, so that the parcel volume prediction model may capture the correlation between these variables, thereby ensuring the prediction accuracy of the parcel volume prediction model.

Step S4032: inputting the prediction prompt information into the parcel volume prediction model to obtain a first parcel prediction volume of the time-series bucket corresponding to the first prediction time.

After the prediction prompt information is obtained, the prediction prompt information is input into the parcel volume prediction model to obtain the first parcel prediction volume. Since the prediction prompt information is obtained based on the second time-series sub-data, and the second time-series sub-data corresponds to the time-series bucket, the obtained first parcel prediction quantity also corresponds to the time-series bucket. Exemplarily, the parcel volume of the time-series bucket in each of the next N days is predicted.

Step S4033: fusing first parcel prediction volumes of time-series buckets corresponding to the same area for the first prediction time to obtain the parcel volume prediction result for the same area for the first prediction time.

Since the resource acquisition spaces of the same area may be distributed in a plurality of time-series buckets, all time-series buckets belonging to the same area may be inquired through a mapping relationship among area, time-series bucket, and resource acquisition space. The first parcel prediction volumes of the inquired time-series buckets at the same prediction time node are accumulated to obtain the parcel volume prediction result for the same area for the first prediction time.

According to the parcel volume prediction method provided in the embodiment, the parcel volume prediction model provides the output for each time-series bucket, that is, the first parcel prediction volume of the time-series bucket corresponding to the first prediction time is obtained. On this basis, the first parcel prediction volumes of the time-series buckets corresponding to the same area are fused to obtain the parcel volume prediction result of the same area for the first prediction time. The parcel prediction model is built based on a large language model, and the prediction is performed in a manner of probability-based sampling. In this way, although the prediction value generated for a single bucket fluctuates to some extent, the parcel volume prediction result of the same area for the first prediction time obtained through aggregation has good robustness.

In some optional implementations, the method further includes a training process of the parcel volume prediction model, which specifically includes the following steps.
Step d1: configuring the parcel volume prediction model.
Step d2: creating a sample dataset, wherein the sample dataset comprises third time-series data within a second historical duration.
Step d3: training, using the sample dataset, the parcel volume prediction model, wherein the parcel volume prediction model is trained to output a parcel prediction volume at a specified time.

The parcel volume prediction model may be built on the basis of a large language model, for example, a non-artificially aligned base model. The training of the parcel volume prediction model is based on the sample dataset, and therefore, the sample dataset needs to be created before training.

The sample dataset includes the third time-series data within the second historical duration, where the generation manner of the third time-series data is similar to that of the second time-series data. For details, reference may be made to the generation process of the second time-series data in the embodiment shown in FIG. 3, which is not repeated herein.

Exemplarily, the differences from the generation process of the second time-series data may include: the first time-series data is obtained based on the time-series data of the first historical duration, and the third time-series data is obtained based on the time-series data of the third historical duration. For example, the first historical duration is 14 days, and the third historical duration is 300 days, etc., but the above examples are not limiting, and other durations are also acceptable. It should be noted that the third historical duration is greater than the first historical duration.

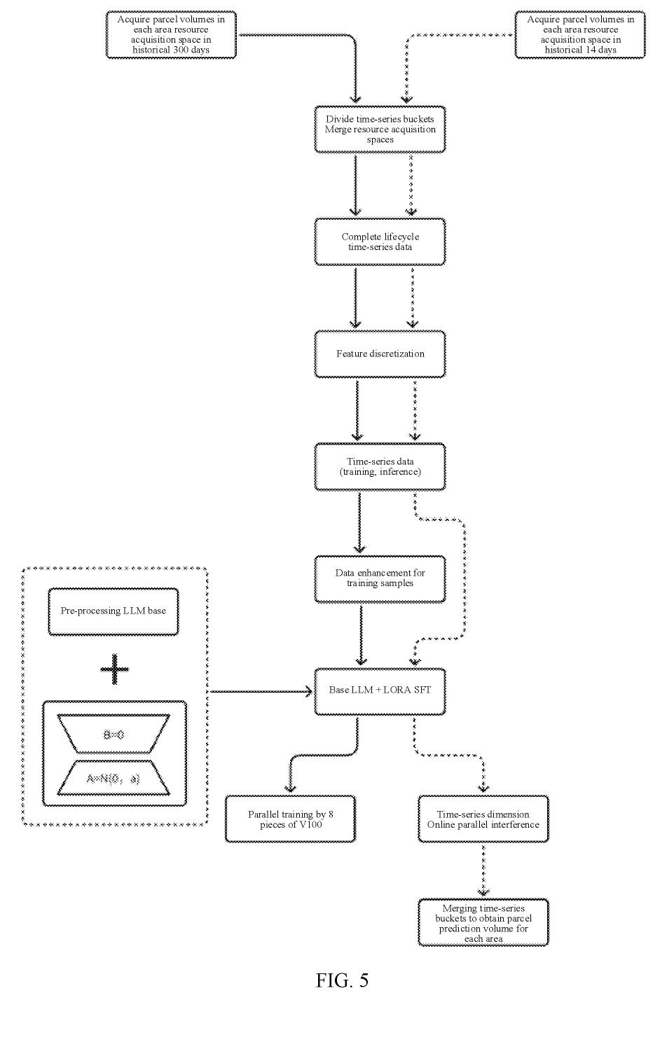

Exemplarily, FIG. 5 shows the processes of model training and model inference. The solid line in FIG. 5 represents the model training process, and the dotted line represents the model inference process.

The training process takes the third historical duration of 300 days as an example. Since there are at least hundreds of thousands of trainable parameters, tens of thousands of pieces of time-series data are usually required for model training to effectively prevent overfitting during the training process. Especially in the business growth stage, a future parcel volume often exceeds a past parcel volume. For the time-series prediction task, the training data for the model should cover time-series segments that may appear in the future to enable more accurate prediction.

Therefore, if only the training data in the area dimension is used, the number of samples may be only several hundreds to thousands in the past 300 days, and the historical parcel volume features in the training data are generally lower than the predicted parcel volume features. Therefore, in data engineering, it is necessary to further refine the prediction in the area dimension to a finer granularity, such as a specific prediction in the dimension of resource acquisition space. In this way, the diversity of data may be significantly improved, so as to better meet the requirements of model training and enhance the generalization ability and prediction accuracy of the model.

Each resource acquisition space may generate several hundreds of pieces of sample data, and several thousands of resource acquisition spaces may generate hundreds of thousands of pieces of sample data, which may greatly increase the diversity of data. However, the daily parcel volumes between different resource acquisition spaces varies greatly. Although the data in the dimension of resource acquisition space increases the diversity of the training data, it reduces the stability of the model training.

To balance the diversity of samples and the stability of the target variable, for the acquired third time-series data, preprocessing, including but not limited to: bucketizing, lifecycle determination, and feature discretization, etc., may be performed first.

Specifically, the number of time-series buckets (buckets) is set first, and then a hash method is used to perform a bucketizing operation on the resource acquisition spaces. After bucketizing, the sum of historical parcel volumes of resource acquisition spaces at the same time node in each time-series bucket is acquired as the historical parcel volume feature of the time-series bucket at that time node. In this way, the diversity of data can be improved while the stability of the target variable can be maintained, thereby improving the effect of model training.

Considering that some resource acquisition spaces may be shut down after operating for several months in the past 300 days, the lifecycle of a time-series bucket (bucket) is defined. For a time-series bucket, the time when a parcel volume first exists is used as the start of the lifecycle, and the time when a parcel volume last exists is used as the end of the lifecycle. During the period from the start of the lifecycle to the end of the lifecycle of the time-series bucket, if there is no parcel volume data on a certain day, zero-filling is performed, and the time-series data is truncated according to the end time of the bucket lifecycle, and only the time-series data from the start of the lifecycle to the end of the lifecycle of each time-series bucket is retained.

For example, the third time-series data is the data in the past 300 days. For the resource acquisition space in the time-series bucket, if there is no data generated in the first 30 days, the number of days of valid time-series data is considered to be 270 days. Then, the data in these 270 days is subsequently completed and is subsequent to time-series segment division, to obtain the time-series data of the first historical duration. For example, if the data in the past 14 days is used to predict the parcel volume in the next 4 days, the length of the time-series segment is 18 days. If the data in the past 14 days is used to predict the parcel volume in the next 2 days, the length of the time-series segment is 16 days.

The sensitivity of the parcel volume prediction model to the recent trend change of the time-series data may be controlled by setting the time length of the historical time-series data of each training sample. The shorter the historical sequence length, the more sensitive it is to trend changes, and the longer the historical sequence length, the more stable the prediction result.

Since the large language model is good at dealing with text and discrete data, when using the large language model for the time-series regression task, it is necessary to discretize the continuous multi-variable features. For example, for some future known plan data, equal-frequency discretization, equidistant discretization or stepped discretization may be performed, and stepped discretization may be selected to prevent overfitting.

The stepped discretization uses a minimum value of the parcel volumes in the time-series data as the reference value (baseline), and determines an initial equidistance by multiplying the reference value by an initial discretization coefficient (coeff, initialized to 0.7 here). Specifically, let the multiple = planned data (planned_data) / reference value. The greater the multiple, the greater the modified discretization coefficient. For example, for the part where the planned data is less than the reference value, the equidistant value is the reference value multiplied by the coefficient, that is, equidistance = baseline * coeff; for the part where the planned data is greater than the reference value and less than or equal to 2 times the reference value, the modified discretization coefficient is 2, and equidistance = baseline * coeff * 2; for the part where the planned data is greater than 2 times the reference value and less than or equal to 3 times the reference value, the modified discretization coefficient is 3, and equidistance = baseline * coeff * 3, and so on.

Since the time-series data of logistics parcel volume prediction has both future known covariates and historical multiple-variable information, to capture the correlation between these variables, the large language model may be used for supervised fine-tuning (SFT) to learn the implicit pattern information in a large amount of training data, thereby performing generative prediction.

To enable the large language model to learn the future known covariates and historical multiple variable information in the time-series data, input-output data pairs may be constructed as the training data.

Exemplarily, the sample dataset includes a plurality of sample subsets, the sample subset includes sample time-series data of a first duration, and the sample time-series data of the first duration is obtained by sampling time-series data of a second duration, the second duration being greater than the first duration.

After time-series segment division of time-series data is performed, the time-series data of the second duration is obtained, and sampling may be performed on this basis to obtain the sample time-series data of the first duration. For example, the second duration is 14 days, and the first duration is 7 days. The time-series data of the past 14 days may be randomly sampled to obtain the time-series data of 7 days, which would be used as the sample time-series data.

The time-series data of the first duration obtained by sampling the time-series data of the second duration is used as the sample subset, which may prevent overfitting and increase the robustness of the training model.

Exemplarily, the sample dataset includes a first sample subset and a second sample subset, the first sample subset includes a parcel volume at a specified time node, and the second sample subset is obtained by performing sample enhancement on the first sample subset.

There may exist very important data in the training data, such as the data at the specified time node. At the specified time node, the parcel volume will increase significantly, but the amount of this part of data is relatively small, usually only a few days in a month are specified time nodes. Considering the above reasons, it is necessary to perform random sampling on the data containing the specified time node in the output data of the training sample to finally generate the sample volume at the specified time node, thereby ensuring that the ratio of the sample volume at a non-specified time node to the sample volume at the specified time node is close to 1:1, and the total number of samples is several hundreds of thousands.

There may be a sharp increase in the parcel volume at the specified time node, but the sample amounts at the specified time node is relatively small. Therefore, the sample enhancement is performed on the first sample subset corresponding to the specified time node to increase the sample volume at the specified time node, thereby ensuring that the model training result has high accuracy for the parcel volume prediction at the specified time node.

After the training dataset is obtained, the training dataset can be used for training the parcel volume prediction model. Exemplarily, since the input and output of the large language model are both text data, while the time-series prediction is usually pure digital data, in order to make the input and output of the model both be digit and remember the pattern of the training data, it is necessary to fine-tune the large language model. During fine-tuning, 8 32G v100 graphics cards may be used for parallel training, and the video memory occupancy may be reduced by reducing the batch_size of training.

In the selection of the base model of the parcel volume prediction model, considering that the output of the model after fine-tuning should return digit as much as possible, a non-artificially aligned base model is selected here. Meanwhile, to save video memory, a large model of about 6 billion (6B) is selected.

The fine-tuning manner uses the Low-Rank Adaptation (LORA) technology, that is, the LORA is used to fine-tune the model, and no extra time consumption will be added during model inference. Moreover, when the parcel volume prediction model is used for inference, the prediction result is output in a manner of probability-based sampling. In this way, although the generated prediction value fluctuates to some extent for a single time-series bucket, the final prediction result of each area obtained through time-series bucket -> area aggregation shows good robustness.

As a specific application embodiment of an embodiment of the present disclosure, in a logistics scenario, a logistics party submits a parcel volume prediction request through the terminal 101 shown in FIG. 1, and the parcel volume prediction request includes a prediction area and a prediction time. Correspondingly, after receiving the parcel volume prediction request, the server 102 shown in FIG. 1 obtains the parcel prediction volume in the prediction area at the prediction time by performing the parcel volume prediction method described in the embodiments of the present disclosure, and feeds back the prediction result to the terminal 101. Subsequently, the logistics party performs logistics scheduling based on the parcel prediction volume.

In the embodiment, a parcel volume prediction apparatus is further provided. The apparatus is configured to implement the above embodiments and preferred implementations, which will not be repeated herein. As used below, the term “module” may implement a combination of software and/or hardware for a predetermined function. Although the apparatus described in the following embodiments is preferably implemented in software, implementation in hardware, or a combination of software and hardware are also possible and contemplated.

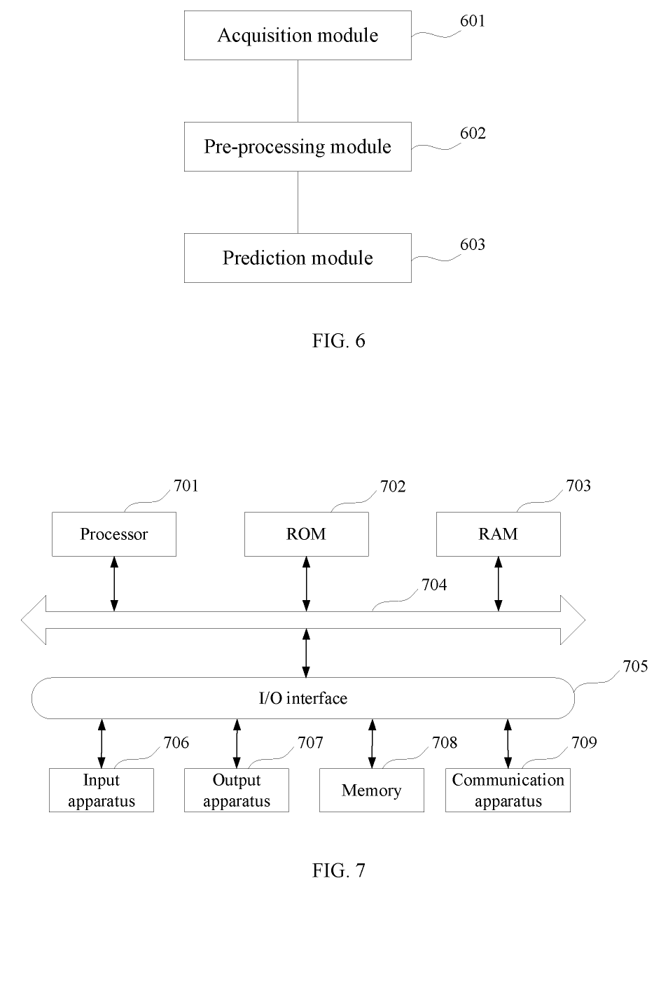

The embodiment provides a parcel volume prediction apparatus, as shown in FIG. 6, including:
an acquisition module 601, configured to acquire first time-series data within a first historical duration and parcel plan data for a first prediction time, wherein the first time-series data indicates a relationship between a time node and parcel information, wherein the parcel information comprises an actual parcel volume and area information, and wherein the area information indicates an area to which a resource acquisition space corresponding to a parcel belongs.
a preprocessing module 602 configured to pre-process the first time-series data to obtain second time-series data, wherein the pre-processing comprises at least one of time-series data division, time-series data arrangement, and time-series data discretization.
a prediction module 603 configured to predict, using a parcel volume prediction model, a parcel volume for the first prediction time to obtain a parcel volume prediction result for the area for the first prediction time, wherein the parcel volume prediction model is configured to output the parcel volume prediction result based on the second time-series data and the parcel plan data for the first prediction time.

In some optional implementations, the preprocessing module 602 includes:
a bucketizing unit, configured to bucketize, based on resource acquisition spaces in the area information, the first time-series data to obtain data in time-series buckets, wherein the data in the time-series buckets comprise time-series sub-data of a plurality of resource acquisition spaces in the same area.
a lifecycle determination unit, configured to d determine, based on the data in a time-series bucket, a lifecycle of the time-series bucket.
a data processing unit, configured to process, based on the lifecycle, the data in the time-series bucket to obtain second time-series sub-data of the time-series bucket, wherein the second time-series data comprises the second time-series sub-data of all the time-series buckets.

In some optional implementations, the bucketizing unit includes:
a first determination sub-unit, configured to determine resource acquisition spaces in a same area in the first time-series data and the number of time-series buckets; and
a bucketizing sub-unit, configured to bucketize, based on the resource acquisition spaces in the same area and the number of time-series buckets, the first time-series data to obtain the data in the time-series bucket.

In some optional implementations, the lifecycle determination unit includes:
a time acquisition sub-unit, configured to acquire, for the data in the time-series bucket, a first time when a parcel volume first exists and a second time when a parcel volume last exists; and
a lifecycle determination sub-unit, configured to use the first time as a start time of the lifecycle and the second time as an end time of the lifecycle.

In some optional implementations, the data processing unit includes:
a filling sub-unit, configured to perform parcel volume filling for a full lifecycle for time-series sub-data of the resource acquisition space in the time-series bucket to obtain third time-series sub-data of the resource acquisition space.
a merging sub-unit, configured to merge parcel volumes at a same time node for the third time-series sub-data of all resource acquisition spaces in the time-series bucket to obtain the second time-series sub-data of the time-series bucket.

In some optional implementations, the merging sub-unit includes:
an accumulation sub-unit, configured to accumulate the parcel volumes at the same time node for all third time-series sub-data in the time-series bucket to obtain fourth time-series sub-data.
a discretization sub-unit, configured to performing feature discretization on the fourth time-series sub-data to obtain the second time-series sub-data.

In some optional implementations, the discretization sub-unit includes:
a reference value determination sub-unit, configured to determine an initial discretization coefficient and a minimum value of parcel volumes in the fourth time-series sub-data, and use the minimum value as a reference value.
a modified coefficient determination sub-unit, configured to determine a modified discretization coefficient based on a size relationship between a planned parcel volume corresponding to a time node in the fourth time-series sub-data and the reference value; a modification sub-unit, configured to modify, based on the initial discretization coefficient and the modified discretization coefficient, the reference value to obtain an equidistant parameter for the time node; and
a parcel volume processing sub-unit, configured to process, based on the equidistant parameter, a parcel volume corresponding to the time node to obtain the second time-series sub-data.

In some optional implementations, the prediction module includes:
a prompt information determination unit, configured to obtain, corresponding to the time-series bucket, prediction prompt information based on the second time-series sub-data of the time-series bucket and the parcel plan data for the first prediction time.
a prediction unit, configured to input the prediction prompt information into the parcel volume prediction model to obtain a first parcel prediction volume of the time-series bucket corresponding to the first prediction time; and
a fusion unit, configured to fusing first parcel prediction volumes of time-series buckets corresponding to the same area for the first prediction time to obtain the parcel volume prediction result for the same area for the first prediction time.
In some optional implementations, the prediction prompt information includes input prompt information and output prompt information,
the input prompt information includes an input identification, the parcel plan data of the first prediction time, the first prediction time, and parcel target data, parcel actual data, and historical time that are obtained based on the second time-series sub-data of the time-series bucket, and
the output prompt information includes a field of predicted parcel volume and a prediction duration.

In some optional implementations, the parcel volume prediction apparatus further includes:
a configuration module, configured to configure the parcel volume prediction model;
a creation module, configured to create a sample dataset, the sample dataset including third time-series data of second parcels within a second historical duration; and
a training module, configured to train, using the sample dataset, the parcel volume prediction model, wherein the parcel volume prediction model is trained to output a parcel prediction quantity at a specified time.

In some optional implementations, the sample dataset includes a plurality of sample subsets, the sample subset includes sample time-series data of a first duration, and the sample time-series data of the first duration is obtained by sampling time-series data of a second duration, the second duration being greater than the first duration.

In some optional implementations, the sample dataset includes a first sample subset and a second sample subset, the first sample subset includes a parcel volume at a specified time node, and the second sample subset is obtained by performing sample enhancement on the first sample subset.

The parcel volume prediction apparatus provided in an embodiment of the present disclosure may perform the parcel volume prediction method provided in any embodiment of the present disclosure, and has corresponding functional modules for performing the method and achieves advantageous effects. For example, when the parcel volume prediction model is used for parcel volume prediction, not only the historical actual parcel volume is considered, but also the plan data at the prediction time is considered, and the prediction result may be quickly adjusted according to recent data changes, thereby improving the accuracy of parcel volume prediction and meeting the requirements of efficient capacity arrangement for logistics business. Further functional descriptions of the above modules and units are the same as those in the corresponding embodiments above, and will not be repeated herein.

FIG. 7 is a schematic diagram of a structure of an electronic device according to an embodiment of the present disclosure.

Reference is made specifically to FIG. 7 below, which is a schematic diagram of a structure of an electronic device suitable for implementing an embodiment of the present disclosure. The electronic device may include a processor (such as a central processing unit and a graphics processor) 701, which may perform various appropriate actions and processing according to a program stored in a read-only memory (ROM) 702 or a program loaded from a memory 708 into a random-access memory (RAM) 703. The RAM 703 further stores various programs and data required for operations of the electronic device. The processor 701, the ROM 702, and the RAM 703 are interconnected by means of a bus 704. An input/output (I/O) interface 705 is also connected to the bus 704.

Usually, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; a memory 708 including, for example, a magnetic tape and a hard disk; and a communication apparatus 709. The communication apparatus 709 may allow the electronic device to communicate wirelessly or wiredly with other devices to exchange data. Although FIG. 7 shows the electronic device having various apparatuses, it should be understood that it is not required to implement or provide all the apparatuses shown, and more or fewer apparatuses may be implemented or provided alternatively.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 709, or installed from the memory 708, or installed from the ROM 702. When the computer program is executed by the processor 701, the functions defined in the parcel volume prediction method according to an embodiment of the present disclosure are performed.

The electronic device shown in FIG. 7 is merely an example, and should not impose any limitation on the function and scope of use of the embodiments of the present disclosure.

An embodiment of the present disclosure further provides a computer-readable storage medium. The method according to an embodiment of the present disclosure may be implemented in hardware and firmware, or implemented as computer code that may be recorded on a storage medium or originally stored in a remote storage medium or a non-transitory machine-readable storage medium and downloaded through a network and that will be stored in a local storage medium. Therefore, the method described herein may be performed by such software stored on a storage medium using a general-purpose computer, a dedicated processor, or programmable or dedicated hardware. The storage medium may be a magnetic disk, an optical disk, a read-only memory, a random-access memory, a flash memory, a hard disk, or a solid-state disk, etc. Further, the storage medium may include a combination of the above types of memories. It may be understood that the computer, the processor, the microprocessor controller or the programmable hardware includes a storage component that may store or receive software or computer code, and when the software or computer code is accessed and executed by the computer, the processor or the hardware, the parcel volume prediction method shown in the above embodiments is implemented.

A part of the present disclosure may be applied as a computer program product, such as computer program instructions that, when executed by a computer, may invoke or provide the method and/or technical solutions according to the present disclosure through the operations of the computer. A person skilled in the art should understand that the computer program instructions exist in a computer-readable medium in a form including but not limited to a source file, an executable file, an installation parcel file, etc. Accordingly, the computer program instructions are executed by the computer in a manner including but not limited to: the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium accessible by the computer.

Although the embodiments of the present disclosure are described with reference to the drawings, a person skilled in the art may make various modifications and variations without departing from the spirit and scope of the present disclosure, and such modifications and variations fall within the scope defined by the appended claims.

What is Claimed:

1. A parcel volume prediction method, comprising:
acquiring first time-series data within a first historical duration and parcel plan data for a first prediction time, wherein the first time-series data indicates a relationship between a time node and parcel information, wherein the parcel information comprises an actual parcel volume and area information, and wherein the area information indicates an area to which a resource acquisition space corresponding to a parcel belongs;
pre-processing the first time-series data to obtain second time-series data, wherein the pre-processing comprises at least one of time-series data division, time-series data arrangement, and time-series data discretization; and
predicting a parcel volume for the first prediction time using a parcel volume prediction model, to obtain a parcel volume prediction result for the area for the first prediction time, wherein the parcel volume prediction model is configured to output the parcel volume prediction result based on the second time-series data and the parcel plan data for the first prediction time.

2. The method of claim 1, wherein the pre-processing the first time-series data to obtain second time-series data comprises:
bucketizing, based on the resource acquisition spaces in the area information, the first time-series data to obtain data in time-series buckets, wherein the data in the time-series buckets comprise time-series sub-data of a plurality of resource acquisition spaces in the same area;
determining, based on the data in a time-series bucket, a lifecycle of the time-series bucket; and
processing, based on the lifecycle, the data in the time-series bucket to obtain second time-series sub-data of the time-series bucket, wherein the second time-series data comprises the second time-series sub-data of all the time-series buckets.

3. The method of claim 2, wherein the bucketizing, based on the resource acquisition spaces in the area information, the first time-series data to obtain data in time-series buckets comprises:
determining resource acquisition spaces in the same area in the first time-series data and a number of time-series buckets; and
bucketizing, based on the resource acquisition spaces in the same area and the number of time-series buckets, the first time-series data to obtain the data in the time-series buckets.

4. The method of claim 2, wherein the determining, based on the data in the time-series bucket, the lifecycle of the time-series bucket comprises:
acquiring, for the data in the time-series bucket, a first time when a parcel volume first exists and a second time when a parcel volume last exists; and
using the first time as a start time of the lifecycle and the second time as an end time of the lifecycle.

5. The method of claim 2, wherein the processing, based on the lifecycle, the data in the time-series bucket to obtain second time-series sub-data of the time-series bucket comprises:
performing parcel volume filling for a full lifecycle for time-series sub-data of the resource acquisition space in the time-series bucket to obtain third time-series sub-data of the resource acquisition space; and
merging parcel volumes at a same time node for the third time-series sub-data of all resource acquisition spaces in the time-series bucket to obtain the second time-series sub-data of the time-series bucket.

6. The method of claim 5, wherein the merging parcel volumes at a same time node for the third time-series sub-data of all resource acquisition spaces in the time-series bucket to obtain the second time-series sub-data of the time-series bucket comprises:
accumulating the parcel volumes at the same time node for all third time-series sub-data in the time-series bucket to obtain fourth time-series sub-data; and
performing feature discretization on the fourth time-series sub-data to obtain the second time-series sub-data.

7. The method of claim 6, wherein the performing feature discretization on the fourth time-series sub-data to obtain the second time-series sub-data comprises:
determining an initial discretization coefficient and a minimum value of parcel volumes in the fourth time-series sub-data, and using the minimum value as a reference value;
determining a modified discretization coefficient based on a size relationship between a planned parcel volume corresponding to a time node in the fourth time-series sub-data and the reference value;
modifying, based on the initial discretization coefficient and the modified discretization coefficient, the reference value to obtain an equidistant parameter for the time node; and
processing, based on the equidistant parameter, a parcel volume corresponding to the time node to obtain the second time-series sub-data.

8. The method of claim 2, wherein the predicting, using a parcel volume prediction model, a parcel volume for the first prediction time to obtain a parcel volume prediction result for the area for the first prediction time comprises:
obtaining, corresponding to the time-series bucket, prediction prompt information based on the second time-series sub-data of the time-series bucket and the parcel plan data for the first prediction time;
inputting the prediction prompt information into the parcel volume prediction model to obtain a first parcel prediction volume of the time-series bucket corresponding to the first prediction time; and
fusing first parcel prediction volumes of time-series buckets corresponding to the same area for the first prediction time to obtain the parcel volume prediction result for the same area for the first prediction time.

9. The method of claim 8, wherein the prediction prompt information comprises input prompt information and output prompt information;
wherein the input prompt information comprises an input identification, the parcel plan data for the first prediction time, the first prediction time, and parcel target data, parcel actual data, and historical time that are obtained based on the second time-series sub-data of the time-series bucket; and
wherein the output prompt information comprises a field of predicted parcel volume and a prediction duration.

10. The method of claim 1, further comprising:
configuring the parcel volume prediction model;
creating a sample dataset, wherein the sample dataset comprises third time-series data within a second historical duration; and
training, using the sample dataset, the parcel volume prediction model, wherein the parcel volume prediction model is trained to output a parcel prediction volume at a specified time.

11. The method of claim 10, wherein the sample dataset comprises a plurality of sample subsets, the sample subset comprises sample time-series data of a first duration, and the sample time-series data of the first duration is obtained by sampling time-series data of a second duration, wherein the second duration is greater than the first duration.

12. The method of claim 10, wherein the sample dataset comprises a first sample subset and a second sample subset, the first sample subset comprises a parcel volume at a specified time node, and the second sample subset is obtained by performing sample enhancement on the first sample subset.

13. An electronic device, comprising:
at least one memory and at least one processor, the at least one memory and the at least one processor being communicatively connected to each other, the at least one memory storing computer instructions, and
wherein the at least one processor executes the computer instructions to perform:
acquiring first time-series data within a first historical duration and parcel plan data for a first prediction time, wherein the first time-series data indicates a relationship between a time node and parcel information, wherein the parcel information comprises an actual parcel volume and area information, and wherein the area information indicates an area to which a resource acquisition space corresponding to a parcel belongs;
pre-processing the first time-series data to obtain second time-series data, wherein the pre-processing comprises at least one of time-series data division, time-series data arrangement, and time-series data discretization; and
predicting a parcel volume for the first prediction time using a parcel volume prediction model, to obtain a parcel volume prediction result for the area for the first prediction time, wherein the parcel volume prediction model is configured to output the parcel volume prediction result based on the second time-series data and the parcel plan data for the first prediction time.

14. The electronic device of claim 13, wherein the pre-processing the first time-series data to obtain second time-series data comprises:
bucketizing, based on the resource acquisition spaces in the area information, the first time-series data to obtain data in time-series buckets, wherein the data in the time-series buckets comprise time-series sub-data of a plurality of resource acquisition spaces in the same area;
determining, based on the data in a time-series bucket, a lifecycle of the time-series bucket; and
processing, based on the lifecycle, the data in the time-series bucket to obtain second time-series sub-data of the time-series bucket, wherein the second time-series data comprises the second time-series sub-data of all the time-series buckets.

15. The electronic device of claim 14, wherein the predicting, using a parcel volume prediction model, a parcel volume for the first prediction time to obtain a parcel volume prediction result for the area for the first prediction time comprises:
obtaining, corresponding to the time-series bucket, prediction prompt information based on the second time-series sub-data of the time-series bucket and the parcel plan data for the first prediction time;
inputting the prediction prompt information into the parcel volume prediction model to obtain a first parcel prediction volume of the time-series bucket corresponding to the first prediction time; and
fusing first parcel prediction volumes of time-series buckets corresponding to the same area for the first prediction time to obtain the parcel volume prediction result for the same area for the first prediction time.

16. The electronic device of claim 13, wherein, the processor executes the computer instructions to further perform:
configuring the parcel volume prediction model;
creating a sample dataset, wherein the sample dataset comprises third time-series data within a second historical duration; and
training, using the sample dataset, the parcel volume prediction model, wherein the parcel volume prediction model is trained to output a parcel prediction volume at a specified time.

17. A non-transitory computer-readable storage medium, wherein the computer-readable storage medium stores computer instructions, and the computer instructions, when executing by a computer, cause the computer to perform:
acquiring first time-series data within a first historical duration and parcel plan data for a first prediction time, wherein the first time-series data indicates a relationship between a time node and parcel information, wherein the parcel information comprises an actual parcel volume and area information, and wherein the area information indicates an area to which a resource acquisition space corresponding to a parcel belongs;
pre-processing the first time-series data to obtain second time-series data, wherein the pre-processing comprises at least one of time-series data division, time-series data arrangement, and time-series data discretization; and
predicting a parcel volume for the first prediction time using a parcel volume prediction model, to obtain a parcel volume prediction result for the area for the first prediction time, wherein the parcel volume prediction model is configured to output the parcel volume prediction result based on the second time-series data and the parcel plan data for the first prediction time.

18. The non-transitory computer-readable storage medium of claim 17, wherein the pre-processing the first time-series data to obtain second time-series data comprises:
bucketizing, based on the resource acquisition spaces in the area information, the first time-series data to obtain data in time-series buckets, wherein the data in the time-series buckets comprise time-series sub-data of a plurality of resource acquisition spaces in the same area;
determining, based on the data in a time-series bucket, a lifecycle of the time-series bucket; and
processing, based on the lifecycle, the data in the time-series bucket to obtain second time-series sub-data of the time-series bucket, wherein the second time-series data comprises the second time-series sub-data of all the time-series buckets.

19. The non-transitory computer-readable storage medium of claim 18, wherein the predicting, using a parcel volume prediction model, a parcel volume for the first prediction time to obtain a parcel volume prediction result for the area for the first prediction time comprises:
obtaining, corresponding to the time-series bucket, prediction prompt information based on the second time-series sub-data of the time-series bucket and the parcel plan data for the first prediction time;
inputting the prediction prompt information into the parcel volume prediction model to obtain a first parcel prediction volume of the time-series bucket corresponding to the first prediction time; and
fusing first parcel prediction volumes of time-series buckets corresponding to the same area for the first prediction time to obtain the parcel volume prediction result for the same area for the first prediction time.

20. The non-transitory computer-readable storage medium of claim 17, wherein, the computer instructions, when executing by a computer, cause the computer to further perform:
configuring the parcel volume prediction model;
creating a sample dataset, wherein the sample dataset comprises third time-series data within a second historical duration; and
training, using the sample dataset, the parcel volume prediction model, wherein the parcel volume prediction model is trained to output a parcel prediction volume at a specified time.
